(19) United States
(12) Patent Application Publication
(10) Pub. No.: US 2007/0093611 A1
(43) Pub. Date: Apr. 26, 2007

(54) Propylene-based resin

(75) Inventors: Hiroyoshi Nakajima, Ichihara-shi (JP); Katsuhisa Kitano, Ichihara-shi (JP); Makoto Satoh, Chiba-shi (JP)

Correspondence Address: BIRCH STEWART KOLASCH & BIRCH, PO BOX 747, FALLS CHURCH, VA, 22040-0747, US

(73) Assignee: Sumitomo Chemical Company, Limited, Tokyo (JP)

(21) Appl. No.: 11/582,996

(22) Filed: Oct. 19, 2006

(30) Foreign Application Priority Data
Oct. 24, 2005 (JP) 2005-308259

(51) Int. Cl. C08F 10/00

(52) U.S. Cl. 525/333.7

(57) ABSTRACT

A propylene-based resin is disclosed which has at least one kind of functional groups selected from the group (i) consisting of a hydroxyl group, an amino group and a mercapto group, and at least one kind of functional groups selected from the group (ii) consisting of a carboxyl group, an acid anhydride group, epoxy group and an isocyanate group.

### BACKGROUND OF THE INVENTION

1. Technical Field

The present invention relates to propylene-based resin having at least two kinds of functional groups. Particularly, the invention relates to propylene-based resin having high melt tension and excellent moldability.

2. Description of the Related Art

Polypropylene has been widely used in various applications such as automotive interior or exterior materials and components of household electric appliances. On the other hand, modified propylene-based resin has been used as primer or adhesive for polyolefin.

For example Japanese Unexamined Patent Publication No. 2004-51808 discloses, as means for improving adhesion of a primer for polyolefin to a polyolefin molded articles, a composition comprising (C) a graft polymer of (A) a polyolefin or its modified product with (B) an acrylic resin, wherein the ratio of the component (A) to the component (B) in the graft polymer (C) falls within a specific range, a specific amount of specific species of monomers are included in the polymerizable unsaturated monomer components for forming the component (B), and the number average molecular weight and the hydroxyl value of the component (C) are within specific ranges.

Japanese Unexamined Patent Publication Nos. 2004-123776 and 2004-137375 disclose, as means for polarizing a modified polyolefin so that the resin can be used for applications such as paint, adhesive and ink, a modified polyolef in resulting from modification of a polyolefin having an end modified with a specific substituent with a compound such as (meth)acrylic acid or a derivative thereof and styrene derivatives.

However, in fabrication of the polyolefin resin composition or modified polyolefin disclosed in the publications into molded articles, there is a demand for improvement of the materials in melt tension or moldability.

Under such circumstances, an object of the present invention is to provide a propylene-based resin having high melt tension and excellent moldability.

### SUMMARY OF THE INVENTION

The present invention relates to a propylene-based resin comprising: at least one kind of functional groups selected from the group (i) consisting of a hydroxyl group, an amino group and a mercapto group, and at least one kind of functional groups selected from the group (ii) consisting of a carboxyl group, an acid anhydride group, epoxy group and an isocyanate group.

According to the present invention, it is possible to obtain a propylene-based resin having high melt tension and excellent moldability.

### DETAILED DESCRIPTION OF THE INVENTION

The propylene-based resin of the present invention is a propylene-based resin comprising: at least one kind of functional groups selected from the group (i) consisting of a hydroxyl group, an amino group and a mercapto group, and at least one kind of functional groups selected from the group (ii) consisting of a carboxyl group, an acid anhydride group, epoxy group and an isocyanate group. From the viewpoint of workability during production, the at least one kind of functional groups selected from the group (i) consisting of a hydroxyl group, an amino group and a mercapto group which the propylene-based resin of the present invention has is preferably an amino group and/or a hydroxyl group, and more preferably is a hydroxyl group.

From viewpoints of melt tension and mechanical properties, the content of the functional groups selected from the group (i) in the propylene-based resin of the present invention is preferably from 0.01 to 10% by weight, more preferably from 0.02 to 8% by weight, and even more preferably from 0.05 to 5% by weight, based on the weight of the propylene-based resin.

The content of the functional groups selected from the group (i) is determined by the infrared spectrum method disclosed in “New Edition Macromolecule Analysis Handbook” (The Japan Society for Analytical Chemistry, edited by Polymer Analysis Division, Kinokuniya Co., Ltd. (1995)). Hydroxyl groups are quantified on the basis of the absorption based on the O—H stretching vibration observed near the region from 3200 to 3650 cm⁻¹. Amino groups are quantified on the basis of the absorption based on the N—H stretching vibration observed near 3400 cm⁻¹ or near 3500 cm⁻¹. Mercapto groups are quantified on the basis of the absorption based on the S—H stretching vibration observed near the region from 2550 to 2600 cm⁻¹. Thus, the contents of these groups are determined.

When the propylene-based resin of the present invention is a propylene-based resin resulting from graft-polymerization of ethylenically unsaturated bond-containing monomers having functional groups selected from the group (i) to a propylene-based resin, the content of the functional groups selected from the group (i) may be calculated from the content of the graft-polymerized ethylenically unsaturated bond-containing monomers determined by the infrared spectrum method.

From the viewpoint of workability during production, the at least one kind of functional groups selected from the group (ii) consisting of a carboxyl group, an acid anhydride group, an epoxy group and an isocyanate group which the propylene-based resin of the present invention has is preferably a carboxyl group and/or an acid anhydride group.

From the viewpoints of melt tension and mechanical properties, the content of the functional groups selected from the group (ii) which the propylene-based resin of the present invention has is preferably from 0.01 to 10% by weight, more preferably from 0.02 to 8% by weight, and even more preferably from 0.05 to 5% by weight, based on the overall weight of the propylene-based resin of the present invention.

The content of the functional groups selected from the group (ii) is determined by the infrared spectrum method disclosed in “New Edition Macromolecule Analysis Handbook” (The Japan Society for Analytical Chemistry, edited by Polymer Analysis Division, Kinokuniya Co., Ltd. (1995)). Carboxyl groups are quantified on the basis of the absorption based on the C═O stretching vibration observed near the region from 1650 to 1800 cm⁻¹. Acid anhydride groups are quantified on the basis of the absorption based on the C═O stretching vibration observed near the region from 1700 to 1800 cm⁻¹. Epoxy groups are quantified on the basis of the absorption based on the S—H stretching vibration observed near 1250 cm⁻¹. Isocyanate groups are quantified on the basis of the absorption based on the C═N stretching vibration observed near the region from 2000 to 2300 cm⁻¹. Thus, the contents of these groups are determined.

When the propylene-based resin of the present invention is a propylene-based resin resulting from graft-polymerization of ethylenically unsaturated bond-containing monomers having functional groups selected from the group (ii) to a propylene-based resin, the content of the functional groups selected from the group (ii) may be calculated from the content of the graft-polymerized ethylenically unsaturated bond-containing monomers determined by the infrared spectrum method.

In the propylene-based resin of the present invention, the ratio of the number of the functional groups selected from the group (i) to the number of the functional groups selected from the group (ii) is preferably from 99/1 to 1/99, more preferably from 95/5 to 5/95, and even more preferably from 90/10 to 10/90, from the viewpoints of melt tension, moldability, etc.

The melt flow rate (MFR) of the propylene-based resin of the present invention is preferably from 0.1 to 500 g/10 minutes, more preferably from 0.5 to 400 g/10 minutes, and even more preferably from 0.5 to 300 g/10 minutes from the viewpoints of moldability of the propylene-based resin and strength of molded articles of the propylene-based resin. The MFR is a value measured at a temperature of 230° C. and a load of 21.2 N according to ASTM D1238.

The propylene-based resin of the present invention is preferably
(1) a propylene-based resin having, as side chains, a structure derived from ethylenically unsaturated bond-containing monomers having functional groups selected from the group (i) and a structure derived from ethylenically unsaturated bond-containing monomers having functional groups selected from the group (ii), or
(2) a propylene-based resin having, in the main chain, a structure derived from ethylenically unsaturated bond-containing monomers having functional groups selected from the group (i) and a structure derived from ethylenically unsaturated bond-containing monomers having functional groups selected from the group (ii).

Examples of a propylene-based polymer which forms the main chain of the propylene-based resin (1) or a part of the main chain of the propylene-based resin (2) include propylene homopolymers, copolymers of propylene with at least one kind of olefin selected from the group consisting of ethylene and α-olefin, and block copolymers obtained by homopolymerizing propylene and then copolymerizing ethylene and propylene. Such a propylene-based polymer is sometimes referred hereinafter to as a “starting propylene-based polymer.”

Examples of the copolymers of propylene with at least one kind of olefin selected from the group consisting of ethylene and α-olefin include propylene-ethylene random copolymers, propylene-α-olefin random copolymers and propylene-ethylene-α-olefin random copolymers.

The α-olefin used in the above-mentioned propylene-based polymers may be α-olefins having 4 to 20 carbon atoms, examples of which include 1-butene, 2-methyl-1-propene, 2-methyl-1-butene, 3-methyl-1-butene, 1-hexene, 2-ethyl-1-butene, 2,3-dimethyl-1-butene, 1-pentene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene, 1-dodecene. α-Olefins having from 4 to 8 carbon atoms, specifically, 1-butene, 1-pentene, 1-hexene and 1-octene are preferred.

The content of ethylene, the content of α-olefin, or the combined content of ethylene and α-olefin of a propylene-ethylene random copolymer, a propylene-α-olefin random copolymer and a propylene-ethylene-α-olefin random copolymer, which are examples of the aforementioned propylene-based polymer, are typically less than 50 molar % based on the combined content of all monomers in the polymer.

The content of ethylene, the content of α-olefin, or the combined content of ethylene and α-olefin is determined by the infrared spectrum method disclosed in “New Edition Macromolecule Analysis Handbook” (The Japan Society for Analytical Chemistry, edited by Polymer Analysis Division, Kinokuniya Co., Ltd. (1995)).

The propylene-based polymers mentioned above can be produced by using conventional catalysts and conventional polymerization methods.

The conventional catalysts include multisite catalysts and single-site catalysts. Examples of preferable multisite catalysts include catalysts obtained by use of a solid catalyst component comprising a titanium atom, a magnesium atom and a halogen atom. Examples of preferably single-site catalysts include metallocene catalysts.

Examples of such conventional polymerization methods include solution polymerization, slurry polymerization, bulk polymerization and vapor phase polymerization. Such polymerization methods may be used singly or in combination.

For example, polymerization methods disclosed in “New Polymer Production Process” edited by Yasuji SAEKI, published by Kogyo Chosakai Publishing Co. (1994), Japanese Unexamined Patent Publication Nos. 4-323207and 61-287917may also be used.

The ethylenically unsaturated bond-containing monomers having functional groups selected from the group (i) or the ethylenically unsaturated bond-containing monomers having functional groups selected from the group (ii) used for the aforementioned propylene-based resin (1) or propylene-based polymer (2) preferable as the propylene-based resin of the present invention are compounds having functional groups selected from the group (i) or functional groups selected from the group (ii) and also having at least one kind of unsaturated groups in the molecule and/or compounds having a structure capable of being transformed through dehydration or the like into a structure having at least one kind of unsaturated groups in the molecule.

Examples of the ethylenically unsaturated bond-containing monomers having functional groups selected from the group (i) include ethylenically unsaturated bond-containing monomers having a hydroxyl group, ethylenically unsaturated bond-containing monomers having an amino group and ethylenically unsaturated bond-containing monomer having a mercapto group.

Examples of the ethylenically unsaturated bond-containing monomer having a hydroxyl group include hydroxyl group-substituted (or containing) (meth)acrylates, hydroxyl group-substituted (or containing) unsaturated alcohols, hydroxyl group-substituted (or containing) vinyl ethers, hydroxyl group-substituted (or containing) allyl ethers and hydroxyl group-substituted (or containing) alkenylphenols.

The hydroxyl group-substituted (or containing) (meth)acrylates include compounds represented by the following structural formula (1): 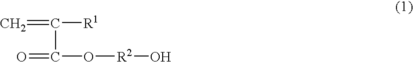
wherein in structural formula (1), R¹ represents a hydrogen atom or an alkyl group having from 1 to 6 carbon atoms and R² represents a methylene group, an alkylene group having from 2 to 20 carbon atoms or a cycloalkylene group having from 3 to 20 carbon atoms.

Examples of the compounds represented by the structural formula (1) include 2-hydroxymethyl (meth)acrylate, 2-hydroxylethyl (meth)acrylate, 2-hydroxypropyl (meth)acrylate, 2-hydroxybutyl (meth)acrylate, polyethylene glycol mono(meth)acrylate, polypropylene glycol mono(meth)acrylate, poly(ethylene glycol-propylene glycol) mono(meth)acrylate, poly(ethylene glycol-tetramethylene glycol) mono(meth)acrylate, poly(propylene glycol-tetramethylene glycol) mono(meth)acrylate and propylene glycol polybutylene glycol mono(meth)acrylate.

The hydroxyl group-substituted (or containing) unsaturated alcohols include allyl alcohol, 9-decen-1-ol, 10-undecen-1-ol and propargyl alcohol. Examples of the hydroxyl group-substituted (or containing) vinyl ethers include 2-hydroxyethyl vinyl ether, diethylene glycol monovinyl ether and 4-hydroxybutyl vinyl ether. The hydroxyl group-substituted (or containing) allyl ethers include 2-hydroxyethyl allyl ether. The hydroxyl group-substituted (or containing) alkenylphenols include p-vinylphenol and 2-propenylphenol.

Examples of the ethylenically unsaturated bond-containing monomers having an amino group include tertiary amino group-containing (meth)acrylates, vinylmorpholines, tertiary amino group-containing ethylenically unsaturated imide compounds, tertiary amino group-containing (meth)acrylamides and quaternary ammonium salt group-containing ethylenically unsaturated compounds.

The tertiary amino group-containing (meth)acrylates include dimethylaminomethyl (meth)acrylate, dimethylaminoethyl (meth)acrylate, dimethylaminopropyl (meth)acrylate and diethylaminoethyl (meth)acrylate.

The vinylmorpholines include 4-vinylmorpholine, 2-methyl-4-vinylmorpholine and 4-allylmorpholine. The tertiary amino group-containing ethylenically unsaturated imide compounds include reaction products of unsaturated carboxylic acid anhydrides, such as maleic anhydride and itaconic anhydride, and amine compounds.

The tertiary amino group-containing (meth)acrylamides include dimethylaminomethyl (meth)acrylamide, dimethylaminoethyl (meth)acrylamide and dimethylaminopropyl (meth)acrylamide.

The quaternary ammonium salt group-containing ethylenically unsaturated compounds include quaternary ammonium salt group-containing unsaturated compounds resulting from cationization of tertiary amino group-containing aromatic vinyl compounds or tertiary amino group-containing ethylenically unsaturated compounds, such as N,N,N-trimethyl-N-(2-hydroxy-3-methacryloyloxypropyl)ammoni um chloride with cationizing agents.

The cationizing agents for use in cationization of tertiary amino group-containing aromatic vinyl compounds and tertiary amino group-containing ethylenically unsaturated compounds include alkyl halide derivatives, alkyl haloacetates, dialkyl sulfates, inorganic acids, organic acids and epihalohydrin adducts of tertiary amine-mineral acid salts.

The alkyl halide derivatives include methyl chloride, ethyl chloride, butyl chloride, octyl chloride, lauryl chloride, stearyl chloride, cyclohexyl chloride, benzyl chloride, phenethyl chloride, allyl chloride, methyl bromide, ethyl bromide, butyl bromide, octyl bromide, a lauryl bromide, stearyl bromide, benzyl bromide, allyl bromide, methyl iodide, ethyl iodide, butyl iodide, octyl iodide, lauryl iodide, stearyl iodide and benzyl iodide.

The alkyl haloacetates include methyl monochloroacetate, ethyl monochloroacetate and ethyl bromoacetate. The dialkyl sulfates include dimethyl sulfate and diethyl sulfate.

The inorganic acids include hydrochloric acid, hydrobromic acid, sulfuric acid and phosphoric acid. The organic acids include formic acid, acetic acid and propionic acid. The epihalohydrin adducts of tertiary amine-mineral acid salts include

N-(3-chloro-2-hydroxypropyl)-N, N, N-trimethylammonium chloride.

Examples of the ethylenically unsaturated bond-containing monomers having a mercapto group include monomers having a structure resulting from substitution of the hydroxyl group of the aforementioned ethylenically unsaturated bond-containing monomer having a hydroxyl group with an SH group.

Examples of the ethylenically unsaturated bond-containing monomers having functional groups selected from the group (ii) include ethylenically unsaturated bond-containing monomers having a carboxyl group, ethylenically unsaturated bond-containing monomers having an acid anhydride group, ethylenically unsaturated bond-containing monomers having an epoxy group and ethylenically unsaturated bond-containing monomers having an isocyanate group.

The ethylenically unsaturated bond-containing monomers having a carboxyl group include unsaturated dicarboxylic acids and unsaturated monocarboxylic acids.

The unsaturated dicarboxylic acids include maleic acid, fumaric acid, chloromaleic acid, himic acid, citraconic acid and itaconic acid.

The unsaturated monocarboxylic acids include acrylic acid, butanoic acid, crotonic acid, vinylacetic acid, methacrylic acid, pentenoic acid, dodecenoic acid, linolic acid, angelic acid and cinnamic acid.

The ethylenically unsaturated bond-containing monomers having an acid anhydride group include the aforementioned unsaturated dicarboxylic acids or unsaturated monocarboxylic acids, specific examples of which include maleic anhydride, himic anhydride and acrylic anhydride.

The ethylenically unsaturated bond-containing monomers having an epoxy group include glycidyl (meth)acrylate, (meth)acryl glycidyl ether and allyl glycidyl ether.

The ethylenically unsaturated bond-containing monomer having an isocyanate group include (meth)acryloyl isocyanate, crotonyl isocyanate, crotonic acid isocyanate ethyl ester, crotonic acid isocyanate butyl ester, crotonic acid isocyanate ethyl ethylene glycol, crotonic acid isocyanate ethyl diethylene glycol, crotonic acid isocyanate ethyl triethylene glycol, (meth)acrylic acid isocyanate ethyl ester, (meth)acrylic acid isocyanate butyl ester, (meth)acrylic acid isocyanate hexyl ester, (meth)acrylic acid isocyanate octyl ester, (meth)acrylic acid isocyanate lauryl ester, (meth)acrylic acid isocyanate hexadecyl ester, (meth)acrylic acid isocyanate ethylene glycol, (meth)acrylic acid isocyanate ethyl diethylene glycol and (meth) acrylic acid isocyanate ethyl triethylene glycol.

Examples of the process for producing the propylene-based resin of the present invention include the following methods (I), (II-1), (II-2) and (III):

(I) a method comprising graft-polymerizing an ethylenically unsaturated bond-containing monomer having functional groups selected from the group (i) and/or its derivative and an ethylenically unsaturated bond-containing monomer having functional groups selected from the group (ii) and/or its derivative to a starting propylene-based polymer;

(II-1) a method comprising copolymerizing an ethylenically unsaturated bond-containing monomer having functional groups selected from the group (i) and/or its derivative, an ethylenically unsaturated bond-containing monomer having functional groups selected from the group (ii) and/or its derivative and propylene;

(II-2) a process comprising copolymerizing an ethylenically unsaturated bond-containing monomer having functional groups selected from the group (i) and/or its derivative, an ethylenically unsaturated bond-containing monomer having functional groups selected from the group (ii) and/or its derivative, propylene and at least one olefin selected from the group consisting of ethylene and α-olefins; and

(III) a method comprising linking a copolymer of an ethylenically unsaturated bond-containing monomer having functional groups selected from the group (i) and/or its derivative and an ethylenically unsaturated bond-containing monomer having functional groups selected from the group (ii) and/or its derivative to a starting propylene-based polymer through graft reaction.

When a derivative of an ethylenically unsaturated bond-containing monomer having functional groups selected from the group (i) and a derivative of an ethylenically unsaturated bond-containing monomer having functional groups selected from the group (ii) are graft-polymerized to a starting propylene-based polymer in the above-mentioned method (I) comprising graft-polymerization, the propylene-based resin of the present invention is obtained by further conducting a conventional chemical treatment.

For example, when an ethylenically unsaturated bond-containing monomer having an esterified hydroxyl group or amidated amino group and an ethylenically unsaturated bond-containing monomer having an esterified carboxyl group or amidated carboxyl group are grafted to a starting propylene-based polymer, followed by treatment utilizing hydrolysis reaction, the esterified hydroxyl group is converted into a hydroxyl group, the amidated amino group is converted into an amino group and the esterified carboxyl group or the amidated carboxyl group is converted into a carboxyl group, and thus a propylene-based resin of the present invention is formed.

Examples of the aforementioned method (I) comprising graft polymerization include:

(I-a) a solution method in which ingredients are heat-treated within a solution in an organic solvent or within an aqueous solution,

(I-b) a bulk method in which ingredients are heat-treated, and

(I-c) a melt kneading method in which all ingredients or some combinations of ingredients are mixed in a mixer such as a Henschel mixer and a ribbon blender to result in a uniform mixture and the mixture is heat-treated in a melt kneading machine such as an extruder.

These methods may be used singly or in combination.

These methods are disclosed, for example, in “Practical Design of Polymer Alloy” Fumio IDE, Kogyo Chosakai Publishing Co. (1996), Prog. Polym. Sci., 24, 81-142 (1999) and Japanese Unexamined Patent Publication No. 2002-308947.

The melt kneading method (c) is preferred. In the melt kneading method (c), melt kneading may be conducted using a Banbury mixer, a plastomill, a Brabender plastograph or a single or twin screw extruder.

From a viewpoint of productivity improvement due to continuous production, melt kneading using a single or twin screw extruder is preferable. More preferable is a method in which ingredients are fully mixed in a mixer and the resulting re-mixed ingredients are fed into a single or twin screw extruder and melt-kneaded.

In the methods (II-1) and (II-2) in which copolymerization is conducted, a catalyst may be used. Examples of such a catalyst include multisite catalysts and single-site catalysts. Examples of preferable multisite catalysts include catalysts obtained by use of a solid catalyst component comprising a titanium atom, a magnesium atom and a halogen atom. Examples of preferably single-site catalysts include metallocene catalysts.

These methods are disclosed, for example, in Macromolecules, 37, 5145-5148 (2004) and U.S. Pat. No. 4,423,196.

The copolymer of an ethylenically unsaturated bond-containing monomer having functional groups selected from the group (i) and/or its derivative and an ethylenically unsaturated bond-containing monomer having functional groups selected from the group (ii) and/or its derivative to be used in the method (III) of linking through graft reaction may be prepared by radical polymerization, anion polymerization, cation polymerization, coordination polymerization. Examples of such polymerization methods include solution polymerization, slurry polymerization, bulk polymerization and vapor phase polymerization. Such polymerization methods may be used singly or in combination. Specific examples of the above-mentioned methods include the methods disclosed in Japanese Unexamined Patent Publication No. 2001-2876 and U.S. Pat. No. 4,423,196.

Examples of the method (III) of linking through graft reaction include:

(III-a) a solution method in which both ingredients are heat-treated within a solution in an organic solvent or within an aqueous solution,

(III-b) a bulk method in which both ingredients are heat-treated,

(III-c) a melt kneading method in which both ingredients are mixed in a mixer such as a Henschel mixer and a ribbon blender to result in a uniform mixture and the mixture is heat-treated in a melt kneading machine such as an extruder.

In order to increase the graft reaction efficiency, a catalyst such as organic peroxide may be added or a propylene-based resin having a functional group may be used. Examples of the propylene-based resin having a functional group include maleic anhydride-modified polypropylene resin. Examples of the method for preparing maleic anhydride-modified polypropylene resin include the methods disclosed in Prog. Polym. Sci., 24, 81-142 (1999), Japanese Unexamined Patent Publication Nos. 2002-308947, 2004-292581, 2004-217753 and 2004-217754.

Examples of commercially available propylene-based resins having functional groups include ADMER (commercial name, made by Mitsui Chemicals, Inc.), MODIC-AP(commercial name, made by Mitsubishi Chemical Corp.), POLYBOND (commercial name, made by Crompton Corp.), YOUMEX (commercial name, made by Sanyo Chemical Industries, Ltd.).

In the production processes of the propylene-based resin of the present invention, electron-donative monomers, such as styrene and divinylbenzene, may be added, if needed.

Further, additives which are widely added to polyolefin resins may be added to the propylene-based resin of the present invention depending on the application thereof. Examples of such additives include stabilizers such as antioxidants, heat stabilizers, neutralizers and UV absorbers, cell inhibitors, flame retardants, flame retardant aids, dispersing agents, antistatic agents, lubricants, antiblocking agents such as silica, colorant such as dyes and pigments, and plasticizers.

Further, tabular or powdery inorganic compounds and whiskers such as glass flake, mica, glass powder, glass beads, talc, clay, alumina, carbon black and wollastonite, and whiskers, etc. may also be added.

### EXAMPLES

The present invention is described below with reference to examples and comparative examples. The materials shown below were used in the examples and comparative examples.

A-1: Propylene-based Resin

A propylene homopolymer (Intrinsic viscosity [η]: 3 dl/g), prepared by a gas phase polymerization process using the solid catalyst component disclosed in Japanese Unexamined Patent Publication No.7-216017.

A-2: Propylene-based Resin

A polymer composed of the two components shown below, which was prepared by the production method of propylene homopolymer (HMS-3) disclosed in an example of Japanese Unexamined Patent Publication No. 2005-146160.

Component 1/Component 2=72/28 (weight ratio)

Component 1: intrinsic viscosity [η]=7.8 dl/g

Component 2: intrinsic viscosity [η]=0.9 dl/g
B-1: 2-Hydroxyethyl methacrylate (made by Tokyo Chemical Industry Co. Ltd.)
B-2: Maleic anhydride (made by Nippon Shokubai Co., Ltd.)
B-3: tert-Butyl peroxybenzoate (trade name: KAYABUTYL B, made by Kayaku Akzo Corp.)
B-4: Organic porous powder (trade name: MP-1000, made by MEMABRANA
B-5: IRGANOX 1010, made by Ciba Specialty Chemicals
B-6: IRGAFOS168, made by Ciba Specialty Chemicals

B-7: 1,3-Bis(tert-butylperoxyisopropyl)benzene (trade name: Perkadox 14, made by Kayaku Akzo Corp.)
B-8: Styrene (made by Tokyo Chemical Industry Co., Ltd.)

The evaluation methods used in the examples and comparative examples are shown below.

(1) Content of Functional Groups (unit: % by weight)

A sample 1.0 g was dissolved in 100 ml of xylene. The solution of the sample was dropped into 1000 ml of methanol under stirring, and thereby the sample was collected by reprecipitation. The sample collected was vacuum dried (80° C., 8 hours) and shaped into a 100-μm film by heat pressing. The resulting film was measured for infrared absorption spectrum. The maleic anhydride graft amount was determined on the basis of absorption near 1780 cm⁻¹ and the 2-hydroxyethyl methacrylate graft amount was determined on the basis of absorption near 1730 cm⁻¹. From the graft amount determined, the contents of hydroxyl groups and acid anhydride groups were calculated.

(2) Melt Flow Rate (MFR, unit: g/10 min)

MFR was measured under the following conditions in accordance with ASTM D792.

| | |
|---|---|
| Measurement temperature: | 230° C. |
| Load: | 21.2 N |

(3) Melt Tension (MT, unit: G)

Melt tension was measured under the following conditions using a melt tension analyzer made by Toyo Seiki Seisaku-Sho, Ltd.

| Orifice: | L/D = 4 (D = 2 mm) | |
|---|---|---|
| Preheating: | 10 | min |
| Extrusion rate: | 5.7 | mm/min |
| Take-off rate: | 0.7 | m/min |
| Measurement temperature: | 190° | C. |

### Example 1

Pellets for evaluation were prepared by mixing (A-1), (B-1), (B-2), (B-3), (B-4), (B-5) and (B-6) uniformly at compounding ratios given in Table 1, followed by melt-kneading in a twin screw kneading extruder (trade name: KZW15-45MG, made by Technovel Corp., co-rotating screw, 15 mm×45 L/D) at a temperature of 180° C. and a screw speed of 500 rpm. The contents of functional groups, MFR and melt tension (MT) of the resulting pellets for evaluation were measured and the results are shown in Table 2.

### Comparative Example 1

Pellets for evaluation were prepared by mixing (A-2), (B-1), (B-3), (B-5) and (B-6) uniformly at compounding ratios given in Table 1, followed by melt-kneading in a twin screw kneading extruder (trade name: KZW15-45MG, made by Technovel Corp., co-rotating screw, 15 mm×45 L/D) at a temperature of 180° C. and a screw speed of 500 rpm. The contents of functional groups, MFR and melt tension (MT) of the resulting pellets for evaluation were measured and the results are shown in Table 2.

### Comparative Example 2

Pellets for evaluation were prepared by mixing (A-1), (B-2), (B-7), (B-8) and (B-5) uniformly at compounding ratios given in Table 1, followed by melt-kneading in a twin screw kneading extruder (trade name: KZW15-45MG, made by Technovel Corp., co-rotating screw, 15 mm×45 L/D) at a temperature of 180° C. and a screw speed of 500 rpm. The contents of functional groups, MFR and melt tension (MT) of the resulting pellets for evaluation were measured and the results are shown in Table 2.

### Comparative Example 3

Pellets for evaluation were prepared by mixing a sample prepared in Comparative Example 1 and a sample prepared in Comparative Example 2 uniformly at a weight ratio of 1/1, followed by melt-kneading in a twin screw kneading extruder (trade name: KZW15-45MG, made by Technovel Corp., co-rotating screw, 15 mm×45 L/D) at a temperature of 180° C. and a screw speed of 500 rpm. The contents of functional groups, MFR and melt tension (MT) of the resulting pellets for evaluation were measured and the results are shown in Table 2.

TABLE 1

| | | Comparative | Comparative |
|---|---|---|---|
| Composition | Example 1 | Example 1 | Example 2 |
| (A) Propylene-based resin | | | |
| Species | A-1 | A-2 | A-1 |
| Amount (parts by weight) | 100 | 100 | 100 |
| (B) Compound | | | |
| Species | B-1 | B-1 | — |
| Amount (parts by weight) | 10 | 40 | — |
| Species | B-2 | — | B-2 |
| Amount (parts by weight) | 1.5 | — | 2.0 |
| Species | B-3 | B-3 | — |
| Amount (parts by weight) | 1.5 | 3.5 | — |
| Species | B-4 | — | — |
| Amount (parts by weight) | 4.6 | — | — |
| Species | B-5 | B-5 | B-5 |
| Amount (parts by weight) | 0.2 | 0.2 | 0.3 |
| Species | B-6 | B-6 | — |
| Amount (parts by weight) | 0.2 | 0.2 | — |
| Species | | | B-7 |
| Amount (parts by weight) | | | 0.1 |
| Species | | | B-8 |
| Amount (parts by weight) | | | 2.1 |

TABLE 2

| | | Comparative Example | | |
|---|---|---|---|---|
| Evaluation result | Example 1 | 1 | 2 | 3 |
| Hydroxyl group content (wt %) | 4.2 | 4.2 | 0 | 2.1 |
| Acid anhydride content (wt %) | 0.9 | 0 | 1.4 | 0.7 |
| MFR (g/10 min) | 1.0 | 168 | 8.9 | 2.0 |
| MT (g) | 11 | 0.2 | 1.3 | 7.2 |

The propylene-based resin of Example 1 has a high melt tension and therefore it excels in moldability.

On the other hand, the propylene-based resin of Comparative Example 1, which has no functional group selected from the group (ii), and the propylene-based resin of Comparative Example 2, which has no functional groups selected from the group (i), are insufficient with respect to melt tension.

Further, the propylene-based resin of Comparative Example 3, which was prepared by melt kneading a propylene-based resin having no functional groups selected from the group (i) and a propylene-based resin having no functional groups selected from the group (ii), is also insufficient with respect to melt tension.

What is claimed is:

1. A propylene-based resin comprising: at least one kind of functional groups selected from the group (i) consisting of a hydroxyl group, an amino group and a mercapto group, and at least one kind of functional groups selected from the group (ii) consisting of a carboxyl group, an acid anhydride group, epoxy group and an isocyanate group.

2. The propylene-based resin according to claim 1, wherein the content of the functional groups selected from the group (i) is from 0.01 to 10% by weight and the content of the functional groups selected from the group (ii) is from 0.01 to 10% by weight, provided that the contents are based on the weight of the propylene-based resin.

3. The propylene-based resin according to claim 1 or 2, wherein the functional groups selected from the group (ii) are carboxyl groups and/or acid anhydride groups.
